(19) United States
(12) Patent Application Publication
(10) Pub. No.: US 2006/0104057 A1
(43) Pub. Date: May 18, 2006

(54) Device and method for in-vivo illumination

(76) Inventors: Jerome Avron, Haifa (IL); Zvika Gilad, Haifa (IL); Semion Khait, Tiberias (IL)

Correspondence Address: PEARL COHEN ZEDEK, LLP, 1500 BROADWAY 12TH FLOOR, NEW YORK, NY, 10036, US

(21) Appl. No.: 11/280,468

(22) Filed: Nov. 17, 2005

Related U.S. Application Data
(63) Continuation-in-part of application No. 10/974,979, filed on Oct. 28, 2004.

(51) Int. Cl. B60Q 1/26

(52) U.S. Cl. 362/227

(57) ABSTRACT

The invention provides a device, system and method for in-vivo imaging, for example, using an in vivo imaging device including a circuit board having rigid sections and flexible sections. The in vivo imaging device may include, for example, a circuit board having at least one rigid portion and at least one flexible portion, wherein said at least one rigid portion has one or more light sources integrated therein. The in-vivo imaging device may include a hybrid illumination unit. The hybrid illumination unit may include, for example, a plurality of light sources, resistors and an optical resin.

### CROSS-REFERENCE TO RELATED APPLICATIONS

This application is a continuation-in-part of U.S. patent application Ser. No. 10/974,979, filed Oct. 28, 2004, which claims priority from U.S. Provisional Application No. 60/638,382, filed on Dec. 27, 2004, which are hereby incorporated by reference.

### FIELD OF THE INVENTION

The present invention relates to a device useful for in-vivo imaging, more specifically to a device for providing illumination in-vivo.

### BACKGROUND OF THE INVENTION

Known devices may be helpful in providing in-vivo imaging. Autonomous in-vivo imaging devices, such as swallowable or ingestible capsules or other devices may move through a body lumen, imaging as they move along. In-vivo imaging may require in-vivo illumination, for example, using one or more light sources or illumination units for example Light Emitting Diodes (LEDs) OLEDs (Organic LED) or other suitable sources or units positioned inside an in-vivo imaging device

In some in-vivo devices, such as ingestible imaging capsules, the electronic components within the capsule, such as light sources, may be arranged on a board or on several boards, for example on a printed circuit board (PCB). In some cases proper alignment or positioning of components, such as light sources, may be difficult to achieve.

### SUMMARY OF THE INVENTION

Thus the present invention provides, according to some embodiments, an in-vivo sensing device such as an imaging device including an illumination sub system, such as a hybrid light source. According to one embodiment the hybrid light source may include, for example, a substrate or support, such as a PCB, for holding one or more light sources, for example, LEDs, OLEDs or other suitable light sources.

The need for a light source, for example a hybrid light source stems from the growing demand for an in-vivo device characterized by a high level of detail and finish which enables exact and powerful illumination in accordance with the highly specific demands of the in-vivo device. Also there is a need for an in-vivo device that has already been calibrated and fitted, for example with the necessary light source prior to it's insertion into the in-vivo device. Thus, according to one embodiment of the invention, a pre-calibrated and arranged hybrid light source may fit into the in-vivo device, for example a swallowable capsule, so highly expensive and time consuming additional production steps are not necessary.

According to one embodiment, the hybrid light source may include at least a resistor in order to set different levels of illumination.

In another embodiment a plurality of light sources may be mounted on the hybrid light source in order to direct and focus illumination as required by the in-vivo device or operation performed.

In another embodiment, the hybrid light source may be mounted on a circuit board, such as a flexible PCB, which may be folded and inserted to an in-vivo device.

In yet another embodiment of the present invention, the hybrid light source may be manufactured according to several designs, enabling the support to fit into in-vivo devices of different shapes.

The present invention provides, according to some embodiments, an in-vivo sensing device comprising a circuit board having one or more rigid sections or portions, and one or more flexible sections or portions.

In some embodiments, one or more light sources such as LEDs, OLEDs, a LED ring, an illumination ring, an illumination assembly, or other suitable illumination systems may be integrated or embedded, for example, within a rigid portion of the circuit board.

In some embodiments, the circuit board may be manufactured or pre-provided to include one or more integrated light sources such as one or more integrated LEDs, integrated OLEDs or one or more integrated LED rings, illumination assemblies or illumination rings.

Some embodiments of the invention include, for example, an in-vivo imaging system incorporating an in-vivo imaging device including a circuit board having at least one rigid portion and at least one flexible portion, wherein the at least one rigid portion includes at least one embedded light source.

In some embodiments, the first rigid portion includes the embedded light source, and the second rigid portion is connected to a transmitter configured to transmit data.

In some embodiments, the at least one embedded light source is configured to receive power from a power source in a current source mode.

In some embodiments, the at least one embedded light source is configured to receive power from a power source in a voltage source mode.

In some embodiments, the in-vivo imaging system may include a power booster configured to increase a power supplied to the at least one embedded light source.

In some embodiments, the in-vivo imaging system may include a switch configured to automatically and periodically transfer power to the at least one embedded light source.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 shows a schematic illustration of an in-vivo imaging system in accordance with some embodiments of the invention;

FIG. 2A shows a schematic illustration of an illumination circuit in accordance with an embodiment of the invention;

FIG. 2B shows a schematic illustration of an illumination circuit in accordance with another embodiment of the invention;

FIG. 3 shows a schematic illustration of an in-vivo imaging device, according to another embodiment of the invention;

FIGS. 4A-4C show a schematic illustration of a hybrid light source, according to one embodiment of the invention;

FIGS. 5A-5B show a schematic illustration of a circuit board, according to one embodiment of the invention;

FIG. 6 is a flowchart depicting a method for producing a hybrid light source, according to embodiments of the invention;

FIG. 7 is a flowchart depicting a method for producing an in-vivo device which includes a hybrid light source, according to embodiments of the invention;

FIG. 8 is a flowchart depicting a method for in-vivo imaging, according to embodiments of the invention; and

FIG. 9 is a flowchart of a method of manufacturing an in vivo imaging device according to embodiments of the invention.

It should be noted that for simplicity and clarity of illustration, elements shown in the figures have not necessarily been drawn to scale. For example, the dimensions of some of the elements may be exaggerated relative to other elements for clarity. Furthermore, where considered appropriate, reference numerals may be repeated among the figures to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the following detailed description, numerous specific details are set forth in order to provide a thorough understanding of the present invention. However, it will be understood by those skilled in the art that the present invention may be practiced without these specific details. In other instances, well-known methods, procedures, and components have not been described in detail so as not to obscure the present invention.

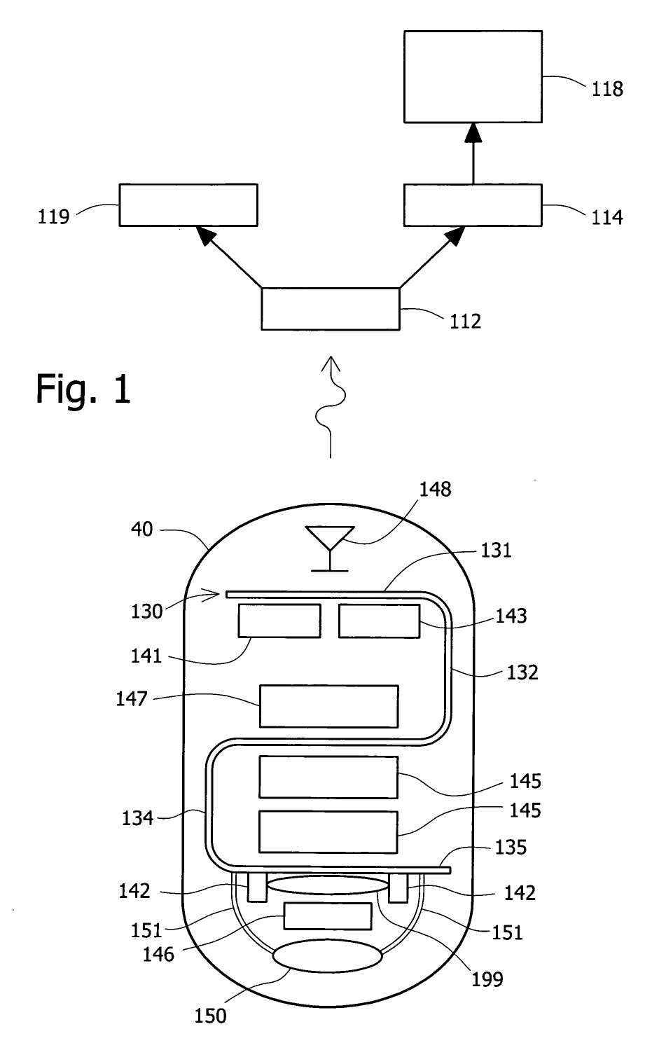

FIG. 1 shows a schematic diagram of an in-vivo imaging system in accordance with an embodiment of the present invention. According to one embodiment of the present invention, the system may include a device 40 having an imager 146, an illumination unit or a light source 142, a power source 145, and a transmitter 141. In some embodiments, device 40 may be implemented using a swallowable capsule, but other sorts of devices or suitable implementations may be used. Outside a patient's body may be, for example, an image receiver 112 (including, for example, an antenna or an antenna array), a storage unit 119, a data processor 114, and a monitor 118.

Devices according to embodiments of the present invention, including imaging, receiving, processing, storage and/or display units suitable for use with embodiments of the present invention, may be similar to embodiments described in U.S. Pat. No. 5,604,531 to Iddan et al., entitled IN-VIVO VIDEO CAMARA SYSTEM, and/or in U.S. patent application Ser. No. 09/800,470 entitled A DEVICE AND SYSTEM FOR IN-VIVO IMAGING, both of which are assigned to the common assignee of the present invention and which are hereby incorporated by reference. Of course, devices and systems as described herein may have other configurations and other sets of components.

Device 40 typically may be or may include an autonomous swallowable capsule, but device 40 may have other shapes and need not be swallowable or autonomous. Embodiments of device 40 are typically autonomous, and are typically self-contained. For example, device 40 may be a capsule or other unit where all the components are substantially contained within a container or shell, and where device 40 does not require any wires or cables to, for example, receive power or transmit information.

In some embodiments, device 40 may communicate with an external receiving and display system (e.g., through receiver 112) to provide display of data, control, or other functions. For example, power may be provided to device 40 using an internal battery, an internal power source, or a wireless system to receive power. Other embodiments may have other configurations and capabilities. For example, components may be distributed over multiple sites or units, and control information may be received from an external source.

In one embodiment, device 40 may include an in-vivo video camera, for example, imager 146, which may capture and transmit images of, for example, the GI tract while device 40 passes through the GI lumen. Other lumens and/or body cavities may be imaged and/or sensed by device 40. In some embodiments, imager 146 may include, for example, a Charge Coupled Device (CCD) camera or imager, a Complementary Metal Oxide Semiconductor (CMOS) camera or imager, a digital camera, a stills camera, a video camera, or other suitable imagers, cameras, or image acquisition components.

Transmitter 141 may operate using radio waves; but in some embodiments, such as those where device 40 is or is included within an endoscope, transmitter 141 may transmit data via, for example, wire, optical fiber and/or other suitable methods. Other suitable methods or components for wired or wireless transmission may be used.

In one embodiment, imager 146 in device 40 may be operationally connected to transmitter 141. Transmitter 141 may transmit images to, for example, image receiver 112, which may send the data to data processor 114 and/or to storage unit 119. Transmitter 141 may also include control capability, although control capability may be included in a separate component. Transmitter 141 may include any suitable transmitter able to transmit image data, other sensed data, and/or other data (e.g., control data) to a receiving device. For example, transmitter 141 may include an ultra low power Radio Frequency (RF) high bandwidth transmitter, possibly provided in Chip Scale Package (CSP). Transmitter 141 may transmit, for example, via antenna 148. In some embodiments, transmitter 141 and/or another unit in device 40, e.g., a controller or processor 147, may include control capability, for example, one or more control modules, processing module, circuitry and/or functionality for controlling device 40, for controlling the operational mode or settings of device 40, and/or for performing control operations or processing operations within device 40. In some embodiments, transmitter 141 may include a receiver which may receive signals (e.g., from outside a patient's body), for example through antenna 148 or through a different antenna or receiving element. According to some embodiments, signals or data may be received by a separate receiving component in device 40

Power source 145 may include, for example, one or more batteries. For example, power source 145 may include silver oxide batteries, lithium batteries, other suitable electrochemical cells having a high energy density, or the like. Other suitable power sources may be used. For example, power source 145 may receive power or energy from an external power source (e.g., an electromagnetic field generator), which may be used to transmit power or energy to device 40.

Optionally, in one embodiment, transmitter 141 may include a processing unit or processor or controller, for example, to process signals and/or data generated by imager 146. In another embodiment, the processing unit may be implemented using a separate component within device 40, e.g., controller or processor 147, or may be implemented as an integral part of imager 146, transmitter 141, or another component, or may not be needed. The optional processing unit may include, for example, a Central Processing Unit (CPU), a Digital Signal Processor (DSP), a microprocessor, a controller, a chip, a microchip, a controller, circuitry, an Integrated Circuit (IC), an Application-Specific Integrated Circuit (ASIC), or any other suitable multi-purpose or specific processor, controller, circuitry or circuit. In one embodiment, for example, the processing unit or controller may be embedded in or integrated with transmitter 141, and may be implemented, for example, using an ASIC.

In some embodiments, device 40 may include one or more illumination units or light sources 142, for example one or more LEDs, “white LEDs”, OLEDs, or other suitable light sources. Light sources 142 may, for example, illuminate a body lumen or cavity being imaged and/or sensed. An optional optical system 150, including, for example, one or more optical elements, such as one or more lenses or composite lens assemblies, one or more suitable optical filters, or any other suitable optical elements, may optionally be included in device 40 and may aid in focusing reflected light onto imager 146 and/or performing other light processing operations.

Data processor 114 may analyze the data received via receiver 112 from device 40, and may be in communication with storage unit 119, e.g., transferring frame data to and from storage unit 119. Data processor 114 may also provide the analyzed data to monitor 118, where a user (e.g., a physician) may view or otherwise use the data. In one embodiment, data processor 114 may be configured for real time processing and/or for post processing to be performed and/or viewed at a later time. In the case that control capability (e.g., delay, timing, etc) is external to device 40, a suitable external device (such as, for example, data processor 114 or image receiver 112) may transmit one or more control signals to device 40.

Monitor 118 may include, for example, one or more screens, monitors, or suitable display units. Monitor 118, for example, may display one or more images or a stream of images captured and/or transmitted by device 40, e.g., images of the GI tract or of other imaged body lumen or cavity. Additionally or alternatively, monitor 118 may display, for example, control data, location or position data (e.g., data describing or indicating the location or the relative location of device 40), orientation data, and various other suitable data. In one embodiment, for example, both an image and its position (e.g., relative to the body lumen being imaged) or location may be presented using monitor 118 and/or may be stored using storage unit 119. Other systems and methods of storing and/or displaying collected image data and/or other data may be used.

Optionally, device 40 may include one or more sensors 143, instead of or in addition to a sensor such as imager 146. Sensor 143 may, for example, sense, detect, determine and/or measure one or more values of properties or characteristics of the surrounding of device 40. For example, sensor 143 may include a pH sensor, a temperature sensor, an electrical conductivity sensor, a pressure sensor, or any other suitable in-vivo sensor.

According to one embodiment of the invention, the various components of the device 40 may be disposed on a circuit board 130, for example a flexible circuit board or a circuit board having rigid sections and flexible sections. Such circuit boards may be similar to embodiments described in U.S. application Ser. No. 10/879,054 entitled IN-VIVO DEVICE WITH FLEXIBLE CIRCUIT BOARD AND METHOD FOR ASSEMBLY THEREOF, and U.S. application No. 60/298,387 entitled IN-VIVO SENSING DEVICE WITH A CIRCUIT BOARD HAVING RIGID SECTIONS AND FLEXIBLE SECTIONS, each incorporated by reference herein in their entirety.

For example, circuit board 130 may include rigid portions 131, 133 and 135, which may be interconnected through flexible portions 132 and 134. Other numbers, orders or combinations of rigid portions and/or flexible portions may be used.

The one or more flexible portions of circuit board 130 may allow bending, folding, twisting or positioning of circuit board 130 into certain shapes. For example, circuit board 130 may have a “2” shape as a “5” shape, a “6” shape, a “C” shape, or other suitable shapes.

In some embodiments, light sources 142 may be attached to rigid portion 135, or may be integrated or embedded within a surface of rigid portion 142. For example, rigid portion 135 or circuit board 130 may be manufactured such that light sources 142 are an integral part of rigid portion 135. In some embodiments, light sources 142 and rigid portion 135 or circuit board 130 may be an integrative unit, such that light sources 142 may not be easily detached or separated from rigid portion 135 or from circuit board 130, or may be firmly attached to and substantially inseparable from rigid portion 135 or circuit board 130. In some embodiments, light sources 142 may be mounted or arranged on rigid portion 135, for example, in accordance with a pre-defined pattern or arrangement, e.g., having a pre-defined spacing between light sources 142, having an even spacing or uneven spacing between light sources 142, having light sources 142 in similar or various sizes and shapes, or the like.

In some embodiments, multiple light sources 142 (e.g., multiple LED units) may be interconnected, held, controlled, mounted and/or supported using a connecting member, for example, a ring 199. In some embodiments, the ring 199 by itself may have illumination functions. The ring 199 may, for example, connect, place, position, support and/or hold one or more light sources 142. In one embodiment, for example, ring 199 may hold one or more light sources 142 at a pre-defined position or angel, may mediate or assist in providing power to one or more light sources 142, or may mediate or assist in controlling one or more light sources 142. In one embodiment, for example ring 199 may be an integral part of rigid portion 135.

In some embodiments, light sources 142 and/or ring 199 may be formed, manufactured or produced as an integrated or integral part of rigid portion 135. For example, a process of manufacturing rigid portion 135 may include bonding, gluing, soldering, connecting, or otherwise firmly attaching light sources 142 and/or ring 199 as a part of rigid portion 135. Such manufacturing may result in a pre-provided rigid portion 135 having light sources 142 and/or ring 199 integrated therein, and may eliminate the need to assemble or further connect light sources 142 and/or ring 199 to rigid portion 135 after the manufacturing process of rigid portion 135 is completed.

In some embodiments, device 40 may include an optical system 150 having one or more lenses, prisms, lens assembly, apertures, shutters, or other optical components. Optionally, optical system 150 may be supported, held in position, mounted, positioned or placed using a holder 151, for example, a lens holder or a lens assembly holder. Imager 146 may be placed, for example, in proximity to light sources, for example, in a central area of ring 199, and between rigid portion 435 and optical system 150 and/or lens holder 151.

In some embodiments, ring 199 may be placed around lens holder 151, for example, such that lens holder 151 may be surrounded by ring 199. In alternate embodiments, ring 199 may be placed such that at least a portion of lens holder 151 is inside ring 199. Other suitable positioning of ring 199, lens holder 451, optical system 450, imager 146 and/or light sources 142 may be used.

In some embodiments, circuit board 130 may be manufactured to include a rigid portion 135 having integrated light sources 142, and optionally having an integrated ring 199. This may allow, for example, a relatively easier, quicker and/or more efficient production, assembly or manufacturing of device 40, e.g., by eliminating a need to attach or manually attach light sources 442 and/or ring 199 to circuit board 130 and/or to another component of device 40.

In some embodiments, circuit board 130 may be manufactured to have an initial flat, non-twisted or non-folded shape, and may be later folded, bended, twisted or positioned in a desired shape in device 40. For example, circuit board 430 may be folded or re-shaped upon its insertion into device 40, or before encapsulation of circuit board 130 inside device 40.

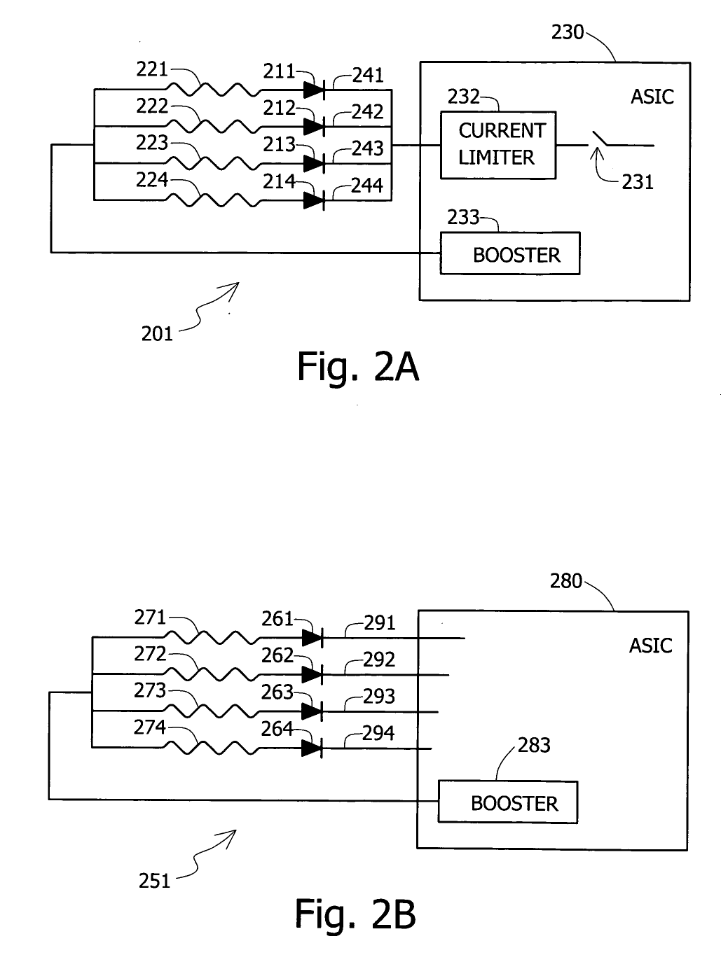

FIG. 2A schematically illustrates an illumination circuit 201 in accordance with some embodiments of the invention.

In some embodiments, illumination circuit 201 may be attached to rigid portion 135, or may be integrated or embedded within a surface of rigid portion 142. For example, rigid portion 135 or circuit board 130 may be manufactured such that illumination circuit 201 is an integral part of rigid portion 135. In some embodiments, illumination circuit 201 and rigid portion 135 or circuit board 130 may be an integrative unit, such that illumination circuit 201 may not be easily detached or separated from rigid portion 135 or from circuit board 130, or may be firmly attached to and substantially inseparable from rigid portion 135 or circuit board 130.

According to some embodiments of the present invention, circuit 201 may include one or more branches of light sources, for example, branches 241, 242, 243 and 244, which may be connected in parallel to a controller or an ASIC 230. Although four branches 241-244 are shown, other numbers of branches may be used.

Branch 241 may include one or more light sources 211 such as LEDs or OLEDS, connected in series to one or more resistors 221. Branch 242 may include one or more light sources 212, connected in series to one or more resistors 222. Branch 243 may include one or more light sources 213, connected in series to one or more resistors 223. Branch 244 may include one or more light sources 214, connected in series to one or more resistors 224. Resistors 221-224 may, for example, regulate, stabilize or otherwise control the current provided to light sources 211-214, respectively.

ASIC 230 may provide power to branches 241-244, for example, in a voltage source mode or in a current source mode.

In one embodiment having a voltage source mode, branches 241-244 may be connected at a first side to a power booster 233 able to modify, boost or increase a voltage provided to branches 241-244. Branches 241-244 may be connected at a second side to a current or a switch 231, which may allow current to pass in pulses so that light sources 211-214 may illuminate in accordance with current pulses, e.g., in accordance with time periods in which an imager acquires images. In one embodiment, for example, switch 231 may automatically or periodically toggle, turn off or turn on light sources 211-214, in accordance with a pre-defined timing scheme, illumination scheme, imaging scheme, pre-defined time intervals, pre-defined illumination time slots, a pulsed illumination scheme, or the like. Other illumination methods may be used, instead of or in addition to pulsed illumination.

In an alternate embodiment having a current source mode, a current limiter 232 may be used to limit, control or otherwise regulate the power provided to branches 241-242.

FIG. 2B schematically illustrates an illumination circuit 251 in accordance with some embodiments of the invention.

In some embodiments, illumination circuit 251 may be attached to rigid portion 135, or may be integrated or embedded within a surface of rigid portion 142. For example, rigid portion 135 or circuit board 130 may be manufactured such that illumination circuit 251 is an integral part of rigid portion 135. In some embodiments, illumination circuit 251 and rigid portion 135 or circuit board 130 may be an integrative unit, such that illumination circuit 201 may not be easily detached or separated from rigid portion 135 or from circuit board 130, or may be firmly attached to and substantially inseparable from rigid portion 135 or circuit board 130.

According to some embodiments of the present invention, circuit 251 may include one or more branches of light sources, for example, branches 291, 292, 293 and 294, which may be connected as shown in FIG. 2B to a controller or an ASIC 280. Although four branches 291-294 are shown, other numbers of branches may be used.

Branch 291 may include one or more light sources 261 such as LEDs or OLEDs, connected in series to one or more resistors 271. Branch 292 may include one or more light sources 262, connected in series to one or more resistors 272. Branch 293 may include one or more light sources 263, connected in series to one or more resistors 273. Branch 294 may include one or more light sources 264, connected in series to one or more resistors 274. Resistors 271-274 may, for example, regulate, stabilize or otherwise control the current provided to light sources 261-264, respectively.

ASIC 280 may provide power to branches 241-244, for example, in a voltage source mode or in a current source mode, e.g., using a booster 283.

The connection of branches 291-294 as shown in FIG. 2B may allow, for example, individual control of branches 291-294 or light sources 261-264 by ASIC 280.

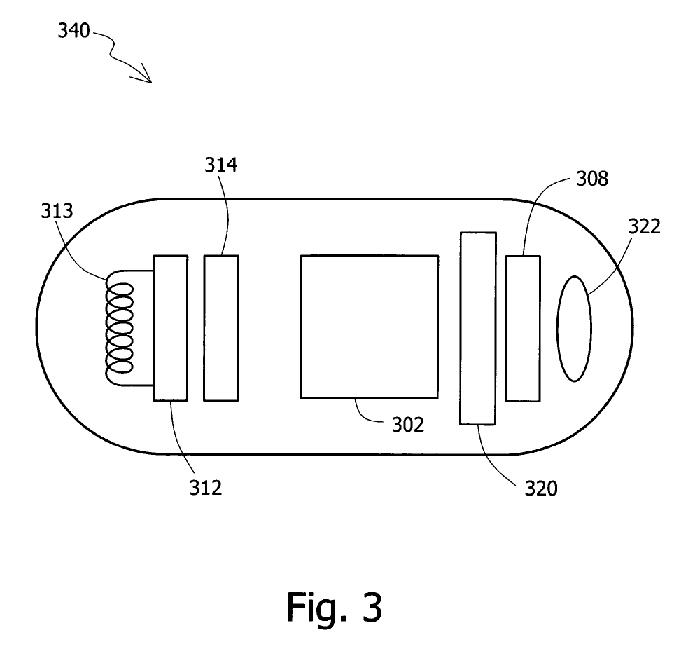

Reference is now made to FIG. 3, which illustrates components of an in-vivo sensing device, for example imaging device 340, according to another embodiment of the present invention. Device 340 typically may be or may include an autonomous swallowable capsule, but device 340 may have other shapes and need not be swallowable or autonomous.

In one embodiment, all of the components may be sealed within the device body (the body or shell may include more than one piece); for example, an imager 308, a hybrid illumination unit 320, power unit 302, optical unit 322 and transmitting 312 and control 314 units, may all be sealed within the device body.

According to one embodiment of the present invention, the various components of the device 340, such as the hybrid illumination unit 320, the power unit 302, the transmitter 312, an the antenna 313 and control 314 units, may be disposed on a support for example a circuit board such as a PCB, a flexible circuit board or a rigid-flex circuit board.

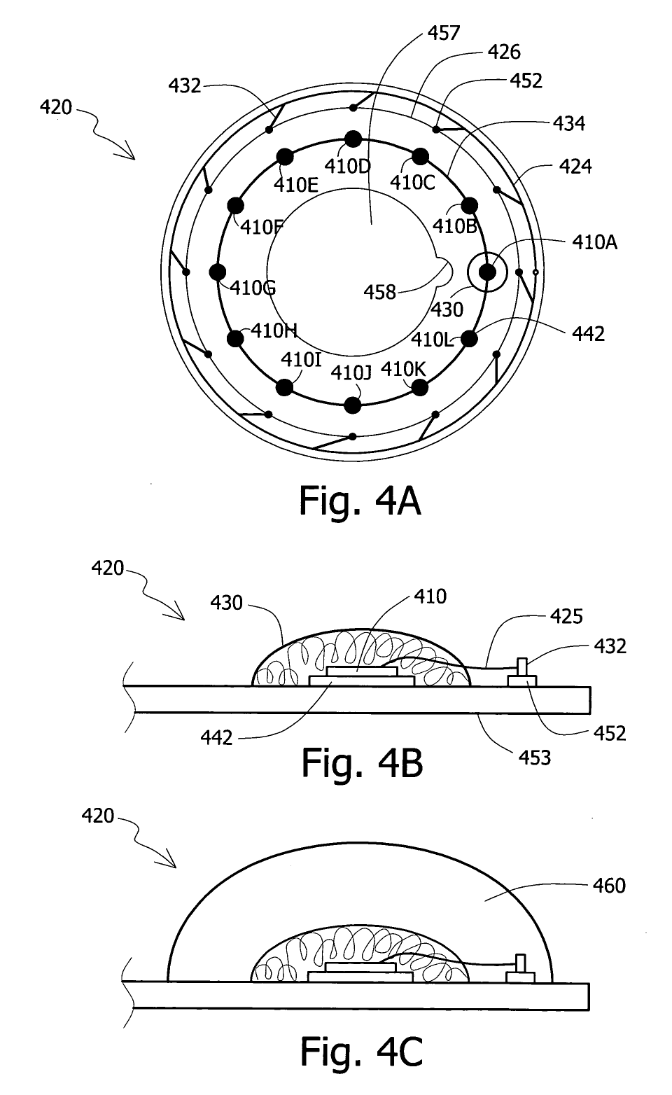

Reference is now made to FIG. 4A showing a schematic view from the top of a hybrid light source 420, in accordance to one embodiment of the present invention.

According to one embodiment, the hybrid illuminating unit 420 may include one or more light sources 410A, 410B, to 410L or may include only one light source. The light source(s) 410A, 410B, to 410L of the hybrid illuminating unit 420 may be white light emitting diodes, such as the light sources disclosed in co-pending U.S. patent application Ser. No. 09/800,470 to Glukhovsky et al. However, the light source(s) 410A, 410B, 410L of the hybrid illuminating unit 420 may also be any other suitable light source, known in the art, such as but not limited to monochromatic LEDs, OLEDs, incandescent lamp(s), flash lamp(s) or any other suitable light source(s).

According to some embodiments the hybrid illumination unit 420 may include a printed circuit board (PCB) made of, for example, silicone or plastic. Other suitable materials may be used. According to one embodiment, the hybrid illumination unit 420 may be ring shaped for example with an internal circle e.g. a rounded hole 457 in its center. Typically, the hybrid illumination unit 420 has compatible measurements for a suitable incorporation into an in-vivo device 340, for example an in-vivo imaging device. The hybrid illumination unit 420 may be of a different shape other than a ring shape e.g. a rectangular or square shape, or of any other form compatible for fitting into an in-vivo device.

According to one embodiment of the invention two printed traces 424 and 434, may be printed on the hybrid illumination unit 420. Each of the printed traces 424 and 434 may be connected either to the positive terminal of the battery 302, or to the negative terminal of the battery 302 through printed trace 453 (shown in FIG. 4B). According to some embodiments of the invention another printed trace 426, which may be located, for example, between printed trace 424 and 434, may include a plurality of pads 452 for wire bonding, for example a plurality of resistors 432.

According to one embodiment of the present invention, conductive pads 442, for example metal pads for chip bonding may be placed or molded on printed trace 434, to provide connections for a plurality of light sources 410A-410L, for example, to a number of LED chips. Each light source 410A-410L may be associated with one or more additional components such as one or more resistor(s) 432, which may be connected to printed trace 426. Resistor(s) 432 may, for example, enable control over the amount of illumination generated by light source 410A-410L. For example, a processor associated with device 340 may be able to use resistor(s) 432 to generate different intensities of light in different parts of the GI tract, such as, 200 lux of light in the small intestine and 300 lux in the colon. Illumination may be controlled and customized for selected illumination functions. Resistor(s) 432 may be variable or permanent, for example a permanent resistor may enable normalized light output from a plurality of light sources.

According to one embodiment of the present invention, an optical resin 430 may be placed over each light source 10A-10L, for example over each LED chip, providing different spectra of illumination (e.g., red, green or blue spectra, infra-red spectra or UV spectra). Furthermore, in certain embodiments, the various light sources 10A-10L may provide different spectra of illumination (e.g., red, green or blue spectra, infra-red spectra or UV spectra). In such embodiments, the illumination provided can be arranged in such a way that the illumination direction is different for each channel employing a different spectrum.

According to some embodiments, a depression 458, positioned in the internal circle of the light source, serves as a direction marker during the hybrid illumination unit 420 installation within the in-vivo device. In an alternate embodiment, depression 58 may be of other suitable shapes.

Reference is now made to FIG. 4B showing a schematic closer view from the side of a light source 410, for example a LED, installed into a hybrid illumination unit 420, in accordance to one embodiment of the present invention.

According to some embodiments, the light source 410, may be placed over a conductive pad 442, for example a chip bonding pad, and may be connected through wire 425 to a pad 452, such as a pad for wire bond. According to some embodiments a resistor 432 may be placed on top of pad 452, for example, in order to control the light source 410 illumination intensity or other parameters such as amplitude.

According to one embodiment a plurality of local control units may be suitably connected to the light sources 410A, 410B, to 410L of the hybrid illumination unit 420 for controlling the energizing of each light source 410A, 410B, to 410L of the hybrid illumination unit 420 and/or for controlling the energizing of a sub-group of light sources, for example light sources 410A to 410B. According to one embodiment, each local control unit may be used for switching one or more of the light sources 410A, 410B, to 410L on or off, or for separately controlling the intensity of the light produced by each light source 410A, 410B, to 410L.

According to one embodiment of the present invention, a conductive pad and/or electrical wire 453, may be placed or molded on the hybrid light source 420, to provide connections for example to battery 402. According to one embodiment of the present invention, directly over the light source 410 an optical resin 430 may be placed, intended to form a different spectra of illumination (for example, as was described with reference to FIG. 4A). FIG. 4C depicts a hybrid illumination unit 420 with lens 460, for example a molded optical lens, mounted on it, in accordance with one embodiment of the present invention. According to one embodiment of the present invention, directly over each light source 410 a lens may be placed, intended to form different illumination direction to each light source. The lens 460 may be made for example from a suitable silicon or transparent plastic, such as for example, ABS, polycarbonates or other suitable materials. Lens 460 may be manufactured by, for example, injection molding. The type of lens employed, its shape and position over the hybrid illumination unit 420, may determine the direction of illumination so that different areas of bodily compartments may be illuminated. Thus, the lens may be chosen according to the in-vivo device's target area, for example, in-vivo devices targeted to image the stomach lumen may require a different lens arrangement than a device targeted to image the esophagus.

According to some embodiments, the hybrid illumination unit 20 may include an amorphous lens, capable of changing its form and focus by way of an electrical current directed towards it, either through remote manual control or automatically as the device travels through the body.

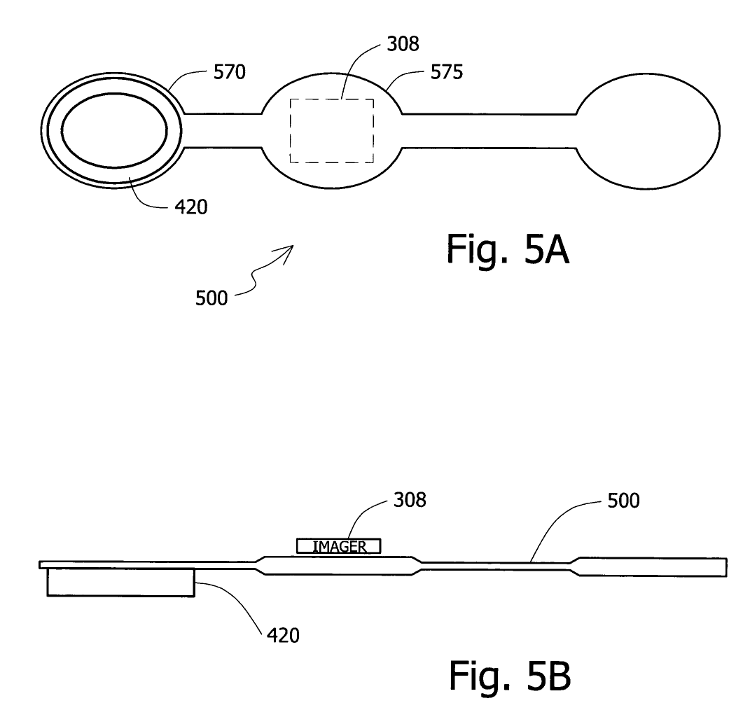

Reference is now made to FIG. 5A showing an example embodiment of a circuit board 500, for example a one sheet flexible circuit board, or a rigid-flex circuit board, in its spread out form, after the hybrid illumination unit 420 has been installed on the circuit board 500 and before it is folded and inserted into an in-vivo device, for example, a capsule, according to an embodiment of the invention.

According to one embodiment a portion or section of the circuit board 500 may have a set of components mounted or disposed upon it. According to one embodiment portion 570 of the circuit board 500 may include, for example the hybrid illumination unit 420, whereas portion 575 of the circuit board 500 may include the imager 308. In alternate embodiments, other components layouts, may be arranged on a circuit board with different shapes or on other in-vivo device's components and/or installed in other compartments of the in-vivo device.

FIG. 5B depicts a side view of the circuit board 500 in its spread form, prior to it's insertion into an in-vivo device, such as device 340, according to one embodiment of the present invention. In this embodiment the hybrid illumination unit 420 is installed on a bottom portion of the circuit board 500, although the hybrid illumination unit 420 may also be installed in several other areas of the circuit board 500.

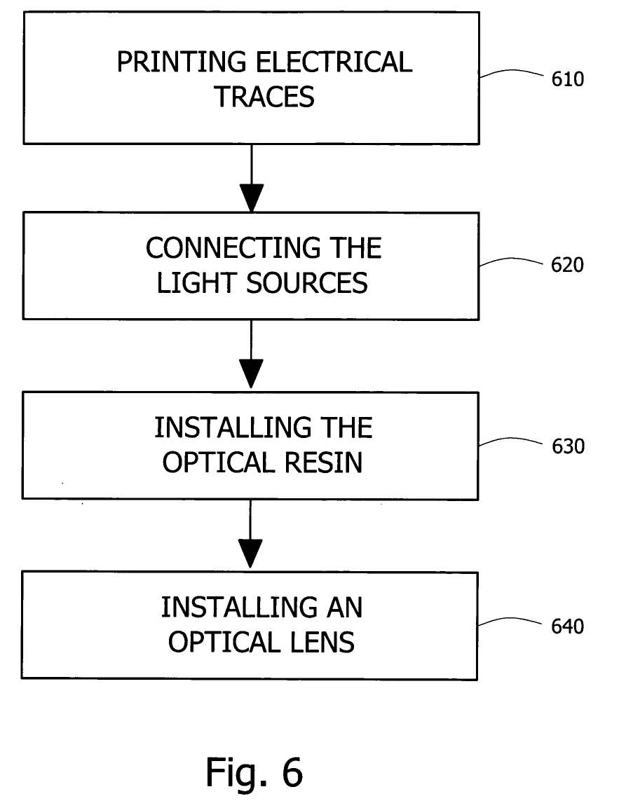

A method for producing an in-vivo imaging device, which may include a hybrid illumination unit, according to different embodiments of the invention is depicted in FIG. 6. According to some embodiments of the present invention, step 610 includes printing electrical traces on a substrate, such as a PCB. For example, a first electrical circuit, which may be wired to pads where the light sources 410 may be connected and a second electrical circuit which may be wired to pads where a plurality of resistors, may be mounted on a PCB. Step 620 includes connecting the light sources to the resistors in order to be able to achieve different illumination intensities. Step 630 includes installing an optical resin above the light sources in order to create a vast spectrum of illumination inside the body. Different joining methods may be used during the hybrid illumination unit 420 assembly and/or for connecting the hybrid illumination unit 420 to the circuit board 500. For example welding methods e.g. laser welding, spin welding, Herman welding and vibration welding, and/or melt down methods, and/or ultrasonic joining and/or fraction fitting. Step 640 includes installing an optical lens above the hybrid light source in order to direct and focus the illumination.

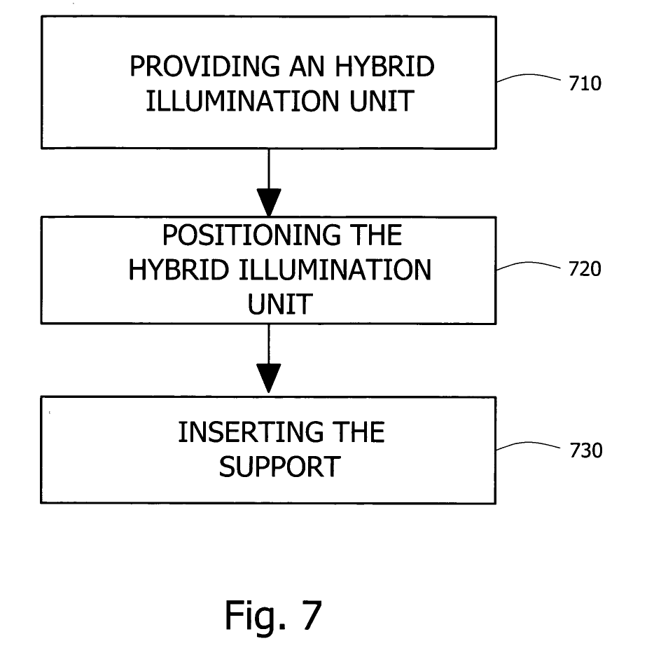

A method for providing in-vivo illumination according to another embodiment is shown in FIG. 7. According to one embodiment the method may include providing a hybrid light source (710) and positioning the hybrid illumination unit on a support (720), for example on a flexible PCB and inserting the support into a housing of an in-vivo device (730). Other steps or combinations of steps may be used.

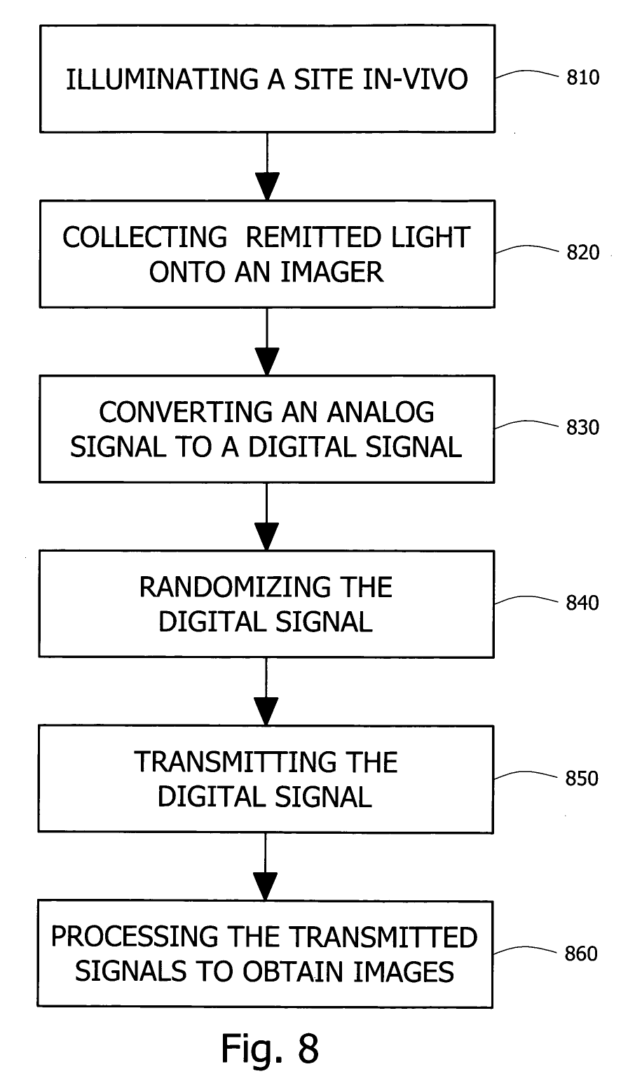

A method for providing in-vivo illumination according to some embodiments of the present invention is shown in FIG. 8. The method for in-vivo imaging may include the following steps: illuminating a site in-vivo (810), for example by using the hybrid illumination unit 420; collecting remitted light onto an imager 308, thereby generating an analog signal (820); converting the analog signal to a digital signal (830); randomizing the digital signal (840); transmitting the digital signal to a receiving system (850) and processing the transmitted signals to obtain images of the in-vivo site (860). Other steps or combinations of steps may be used.

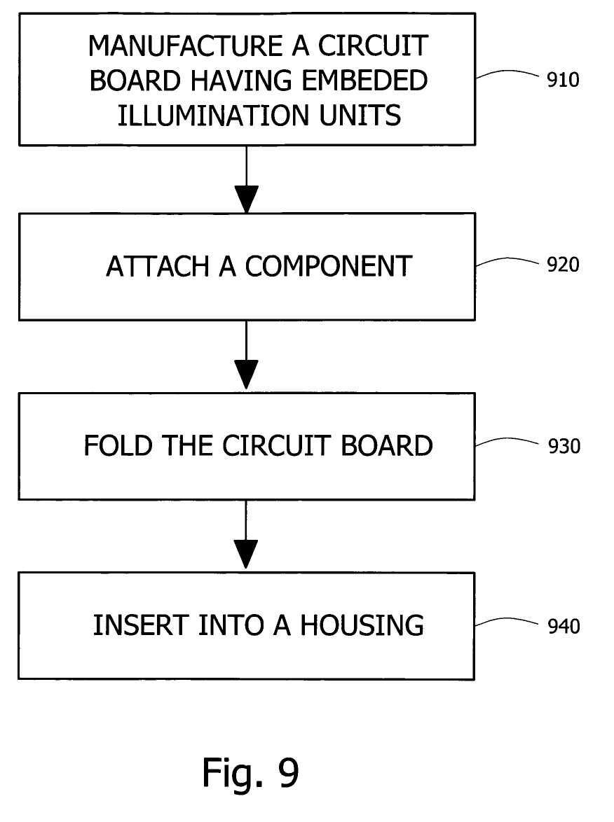

FIG. 9 is a schematic flow-chart of a method of manufacturing an in-vivo imaging device in accordance with some embodiments of the invention.

As indicated at box 910, the method may include manufacturing or providing a circuit board having one or more rigid portions and one or more flexible portions, wherein one or more light sources are embedded or integrated within at least one of the rigid portions.

As indicated at box 920, the method may optionally include attaching or connecting one or more components to a rigid portion of the circuit board. This may include, for example, attaching a lens holder, a LED ring, an imager, a battery, a power source, a sensor, a transmitter, an antenna. or other suitable components.

As indicated at box 930, the method may include folding, bending, twisting and/or shaping of the circuit board or a flexible portion of the circuit board, for example, into a pre-defined shape.

As indicated at box 940, optionally, the method may include inserting the folded circuit board into a suitable housing adapted or configured for in vivo imaging, for example, a housing of a swallowable capsule.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An in-vivo imaging device comprising:
an imager; and
a circuit board having at least one rigid portion and at least one flexible portion, the rigid portion having a light source embedded therein.

2. The device according to claim 1, the rigid portion having an illumination circuit embedded therein.

3. The device according to claim 2, wherein the illumination circuit is arranged in a plurality of branches.

4. The device according to claim 3, wherein the branches are connected in parallel to a controller.

5. The device according to claim 1, wherein the light source is connected in series to a resistor.

6. The device according to claim 1, comprising a connecting member to support a plurality of light sources.

7. The device according to claim 6, wherein the connecting member is ring shaped.

8. The device according to claim 7, wherein the connecting member has illumination functions.

9. The device according to claim 2, comprising a power booster to modify power supplied to the light source.

10. The device according to claim 2, comprising a switch to control illumination.

11. The device according to claim 1, comprising a transmitter.

12. The device according to claim 1, wherein the device is a swallowable capsule.

13. The device according to claim 1, wherein the light source is selected from the group consisting of: a LED, a monochromatic LED, an OLED, an incandescent lamp and a flash lamp.

14. A method for the manufacture of an in-vivo sensing device, the method comprising the steps of:
positioning a hybrid illumination unit on a support; and
folding the support into a device housing.

15. The method according to claim 14, comprising providing an imager on the support.

16. The method according to claim 14, comprising providing a transmitting unit on the support.

17. The method according to claim 14, comprising providing a power unit to the device.

18. The method according to claim 14, comprising providing a control unit to control illumination.

19. The method according to claim 14, comprising:
printing electrical traces on a substrate;
disposing a light source on the electrical traces;
installing a lens above the light source; and
folding the substrate into the device housing.

20. The method according to claim 19, comprising installing an optical resin above the light source.

21. The method according to claim 19, comprising installing a resistor on the electrical traces.
